(19) United States
(12) Patent Application Publication
(10) Pub. No.: US 2026/0336258 A1
(43) Pub. Date: Oct. 29, 2026

(54) POLYURETHANE FOAM-FORMING REACTION MIXTURES, FOAMS FORMED THEREFROM, AND PROCESSES FOR PRODUCING MULTI-LAYER COMPOSITE ARTICLES WITH SUCH FOAMS

(71) Applicant: Covestro LLC, Pittsburgh, PA (US)

(72) Inventors: Peter K. Smith, Imperial, PA (US); Michael T. Wellman, Moundsville, WV (US)

(21) Appl. No.: 19/639,826

(22) Filed: Apr. 6, 2026

Related U.S. Application Data
(60) Provisional application No. 63/792,430, filed on Apr. 22, 2025.

(30) Foreign Application Priority Data
Jun. 10, 2025 (EP) 25181758.1

(51) Int. Cl. B32B 5/24; B29C 43/20; B29K 105/04; B32B 27/40

(52) U.S. Cl. CPC B32B 5/245; B29C 43/203; B32B 27/40; B29K 2105/04; B32B 2266/0278

(57) ABSTRACT

Polyurethane foam-forming reaction mixtures, polyurethane foams formed therefrom, methods for producing multi-layer composite articles containing such foams, and the resulting multi-layer composite articles that may be embodied as, for example, an automotive interior part, such as an automotive hoodliner or headliner. The polyurethane foam-forming reaction mixtures include a polyisocyanate that includes monomeric diphenylmethane diisocyanate, polyphenylpolymethylene polyisocyanate, and an isocyanate-terminated prepolymer, in which the monomeric diphenylmethane diisocyanate, the polyphenylpolymethylene polyisocyanate, and the isocyanate-terminated prepolymer are each present in specified amounts.

### FIELD

This specification pertains to polyurethane foam-forming reaction mixtures, polyurethane foams formed from such reaction mixtures, methods for producing multi-layer composite articles containing such foams by a thermoforming process, and to the resulting multi-layer composite articles that may be embodied as, for example, an automotive interior part, such as an automotive hoodliner or headliner. The polyurethane foam-forming reaction mixtures include a polyisocyanate comprising monomeric diphenylmethane diisocyanate (“mMDI”), polyphenylpolymethylene polyisocyanate (“pMDI”), and an isocyanate-terminated prepolymer based on mMDI and/or pMDI (“PPL”), in which the mMDI, pMDI and PPL are each present in specified amounts.

### BACKGROUND

Polyurethane foams are used in many applications. Among these is the production of automotive interior parts, such as automotive hoodliners and headliners. In such cases, the foam is part of a multi-layer composite that is simultaneously stiff and light in weight. To achieve such properties, the polyurethane foam must be low in density, must have sufficient strength and elasticity to resist breakage during forming, and be stiff enough to prevent the finished part from bending and sagging during finishing operations and final installation.

One method of producing such multi-layer composites is by saturating a layer or some of the layers with liquid adhesive, laying up the composite in a tool, and then curing the adhesive using pressure, heat, moisture and possibly catalyst. In such a process, the typical thermoforming temperature is around 120 °C. Such a process, however, has its disadvantages. First, the adhesive is often a liquid isocyanate that is applied with an open-air roll coater. Such adhesives are sensitive to humidity and have a limited pot life. Second, the weight of liquid adhesive saturated into the composite may be more than the composite itself, working against light-weighting efforts in automotive applications. Third, engineering controls must be in place to protect workers from isocyanate vapors and skin exposure during transfer and lay up. Finally, amine catalysts used to accelerate cure are hazardous and can have a strong, unpleasant odor.

Another method of creating such a multi-layer composite is to use a dry film adhesive between the layers, heating the layers to melt the adhesive, thermoforming and bonding the layers together. In such a process, the adhesive can be incorporated simply as another roller sheet, eliminating the equipment and hazards associated with liquid roll coating, since a cut sheet allows for the composite to be assembled remotely for the thermoforming/bonding operation. A disadvantage is that the adhesive melt temperature is much higher than the wet process, often around 180 °C. In manufacturing headliners, the polyurethane foam must maintain sufficient tensile strength, elongation and compressive strength at such a temperature to resist tearing and crushing. Tearing is considered a defect in the finished part. The foam must resist crushing, that is, it must exhibit sufficient compressive strength to force the outer layers of the composite into the topography of the tool. Moreover, foam with high compressive strength acts as a structural member in bending, allowing immediate handling as the adhesive cools after demolding.

It would, therefore, be desirable to provide polyurethane foam-forming reaction mixtures that can produce polyurethane foams that exhibit desirable physical properties, such as tensile strength, elongation, and compressive strength, at the high temperatures used in a dry film adhesive process for producing a multi-later composite article, such as an automotive hoodliner or headliner. It would also be desirable to provide a dry film adhesive process for producing a multi-layer composite article using such polyurethane foam-forming reaction mixtures.

### SUMMARY

In certain respects, this specification relates to polyurethane foam-forming reaction mixtures that comprise: (1) a polyol; (2) a blowing agent composition; (3) a catalyst; and (4) a polyisocyanate composition comprising: (a) monomeric diphenylmethane diisocyanate (mMDI), (ii) polyphenylpolymethylene polyisocyanate (pMDI); and (iii) an isocyanate-terminated prepolymer based on mMDI and/or pMDI (PPL). In these polyurethane foam-forming reaction mixtures (i) mMDI and pMDI are present in a ratio, by weight, of 0.9:1 to 1.1:1, (ii) PPL is present in an amount of 8 to 12% by weight, based on total weight of the polyisocyanate composition, and (iii) mMDI and PPL are present in a ratio, by weight, of 4.7:1 to 5.3:1.

In other respects, this specification further relates to processes for producing a multi-layer composite article. Such processes may comprise: (a) forming a multi-layer assembly comprising (1) a polyurethane foam core having a pair of opposed major surfaces; (2) a thermoplastic adhesive film deposited over at least one of the major surfaces of the polyurethane foam core; and (3) a fiber-reinforced mat deposited over the thermoplastic adhesive film; (b) melting the thermoplastic adhesive film by heating the multi-layer assembly to a temperature of 150 °C to 250 °C to form a multi-layer composite; and (c) shaping the multi-layer composite. In these processes, the polyurethane foam core comprises the reaction product of a polyurethane foam-forming reaction mixture comprising: (1) a polyol; (2) a blowing agent composition; (3) a catalyst; and (4) a polyisocyanate composition comprising: (i) mMDI; (ii) pMDI; and (iii) a PPL, in which mMDI and pMDI are present in a ratio, by weight, of 0.9:1 to 1.1:1, the PPL is present in an amount of 8 to 12% by weight, based on total weight of the polyisocyanate composition, and mMDI and PPL are present in a ratio, by weight, of 4.7:1 to 5.3:1.

This specification also relates to, among other things, polyurethane foams produced from such polyurethane foam-forming reaction mixtures and to multi-layered composite articles produced by such processes.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the polyol or polyol blend that is being described. In the production of polyurethane foams, hydroxyl groups react with isocyanate groups, —NCO, which are attached to a polyisocyanate. As used herein, the terms “hydroxyl number” and “OH number” refer to the number of reactive hydroxyl groups available for reaction and are expressed as the number of milligrams of potassium hydroxide equivalent to the hydroxyl content of one gram of the polyol (ASTM D4274-16). The term “equivalent weight” refers to the weight of a compound divided by its valence. For a polyol, the equivalent weight is calculated by dividing the molecular weight of the polyol by its functionality or is calculated by dividing 56,100 by the hydroxyl number of the polyol-Equivalent Weight (g/eq)=(56.1×1000)/OH number.

As indicated earlier, in some implementations, this specification relates to polyurethane foam-forming reaction mixtures that comprise, among other things, a polyol. Often, the polyol comprises a blend or two or more different polyols.

In some implementations, the polyol comprises a polyether polyol (1) having a functionality of 2 to 6, such as 2 to 4, 2.5 to 3.5, or 3, and an OH number of 20 to 50 mg KOH/g polyether polyol (1), such as 25 to 40 mg KOH/g polyether polyol (1) or 26 to 32 mg KOH/g polyether polyol (1). Such polyether polyols can, for example, be produced by reaction of alkylene oxide, such as ethylene oxide and/or propylene oxide, with di- or higher functional polyols and/or polyamines, such as trihydric polyols. In some implementations, such a polyether polyol has a (poly)oxyethylene content of 0 to 50% by weight, such as 1 to 40% by weight, 1 to 30% by weight, 10 to 30% by weight, or 10 to 20% by weight, based on the total weight of the polyether polyol (1). In addition, in some cases, the foregoing polyether polyol (1) has more than 50 mol %, such as 70 to 90 mol % or 70 to 80 mol %, of primary OH groups.

Specific examples of suitable such polyether polyols (1) include alkylene oxide addition products of starter compounds with Zerewitinoff-active hydrogen atoms. Suitable starter compounds with Zerewitinoff-active hydrogen atoms which are used for the production of such polyether polyols often have a hydroxyl functionality of 2 to 8, 2 to 6, 2 to 4, or, in some cases, 3. Specific examples of suitable hydroxy-functional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydro-quinone, pyrocatechol, resorcinol, bisphenol F, bisphenol A, 1,3,5-trihydroxybenzene, and condensation products of formaldehyde and phenol or melamine or urea which contain methylol groups. Specific examples of alkylene oxides suitable for preparing such polyether polyols include ethylene oxide (“EO”), propylene oxide (“PO”), 1,2-butylene-oxide or 2,3-butylene oxide and styrene oxide. In some cases, propylene oxide and ethylene oxide are introduced into the reaction mixture individually, in a mixture or successively. If the alkylene oxides are metered in successively, the resulting products contain polyether chains with block structures. Products with ethylene oxide blocks are characterized by increased concentrations of primary end groups. The alkoxylation reaction may be catalyzed using any conventional catalyst including, for example, potassium hydroxide (KOH) or a double metal cyanide (DMC) catalyst.

In some implementations, the foregoing polyether polyol (1) is present in an amount of at least 30% by weight, such as 30 to 60% by weight, 30 to 50% by weight or 30 to 40% by weight, based on total weight of polyols in the polyurethane foam-forming reaction mixture.

In addition, in some implementations, the polyol comprises a polyether polyol (2) having a functionality of 2 to 6, such as 2 to 4, or 2 to 3, and an OH number of 200 to 600 mg KOH/g polyether polyol (2), such as 300 to 600 KOH/g polyether polyol (2), 400 to 600 mg KOH/g polyether polyol (2), or 450 to 550 mg KOH/g polyether polyol (2). Such polyether polyols (2) can, for example, be produced by reaction of alkylene oxide, such as ethylene oxide and/or propylene oxide, with di- or higher functional polyols and/or polyamines, such as di- and/or tri-hydric polyols. In some implementations, such a polyether polyol (2) has a (poly)propylene content of at least 70% by weight, such as at least 80% by weight, at least 90% by weight, at least 95% by weight, or 100% by weight, based on the total weight of the polyether polyol (2).

Specific examples of suitable such polyether polyols (2) include alkylene oxide addition products of starter compounds with Zerewitinoff-active hydrogen atoms. Suitable starter compounds with Zerewitinoff-active hydrogen atoms which are used for the production of such polyether polyols often have a hydroxyl functionality of 2 to 8, 2 to 6, 2 to 4, or, in some cases, 3. Specific examples of suitable hydroxy-functional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydro-quinone, pyrocatechol, resorcinol, bisphenol F, bisphenol A, 1,3,5-trihydroxybenzene, and condensation products of formaldehyde and phenol or melamine or urea which contain methylol groups. Specific examples of alkylene oxides suitable for preparing such polyether polyols include ethylene oxide (“EO”), propylene oxide (“PO”), 1,2-butylene-oxide or 2,3-butylene oxide and styrene oxide. In some cases, propylene oxide and ethylene oxide are introduced into the reaction mixture individually, in a mixture or successively. If the alkylene oxides are metered in successively, the resulting products contain polyether chains with block structures. Products with ethylene oxide blocks are characterized by increased concentrations of primary end groups. The alkoxylation reaction may be catalyzed using any conventional catalyst including, for example, potassium hydroxide (KOH) or a double metal cyanide (DMC) catalyst.

Moreover, in some implementations, the foregoing polyether polyol (2) is present in an amount of at least 40% by weight, such as 40 to 80% by weight, 40 to 70% by weight or 40 to 60% by weight, based on total weight of polyol in the polyurethane foam-forming reaction mixture.

In some implementations, the sum of the amount of polyether polyol (1) and polyether polyol (2) is at least 80% by weight, at least 85% by weight, or at least 90% by weight, based on total weight of polyol that is present in the polyurethane foam-forming reaction mixture.

Moreover, in some of these specific implementations, the polyol comprises at least 60% by weight, such as 60 to 95% by weight or 70 to 90% by weight of a difunctional, trifunctional or mixture of di- and tri-functional hydroxyl polyether polyols. For example, in some cases, such a mixture of difunctional and trifunctional polyether polyols comprises, based on total weight of polyol present in the polyurethane foam-forming reaction mixture: (i) 20 to 40% by weight, such as 25 to 35% by weight, of a glycerin-started (poly)propylene triol having an OH number of 400 to 600 mg KOH/g, such as 450 to 500 mg KOH/g, (ii) 30 to 50% by weight, such as 35 to 45% by weight, of a glycerin-started poly(propylene/ethylene oxide) triol having an OH number of 20 to 50 mg KOH/g, such as 25 to 40 mg KOH/g or 26 to 32 mg KOH/g, and (iii) 10 to 30% by weight, such as 15 to 25% by weight, of a (poly)propylene glycol having an OH number of 400 to 600 mg KOH/g, such as 500 to 600 mg KOH/g.

If desired, the polyol may include other polymeric polyols, such as up to 40% by weight, up to 25% by weight, or up to 10% by weight, based on total weight of polyol, of other types of polymeric polyols, such as polyester polyols. In some cases, however, the polyol does not include any polyester polyol.

The polyurethane foam-forming reaction mixture may, and often does, comprise one or more additional polyols, such as a chain extender and/or crosslinker containing at least two isocyanate-reactive groups and a molecular weight of 60 to 160, specific examples of which include, but are not limited to, glycerin, butanediol, ethylene glycol, diethylene glycol, propylene glycol, ethylenediamine, ethanolamine, triethanolamine, trimethylolpropane and pentaerythritol, including mixtures of two or more thereof. As will be appreciated, some such chain extenders and/or crosslinkers may have a green content due to their being a renewable material, such as glycerin, or a recycled material, such as may be the case with a glycol. In certain embodiments, such a chain extending agent and/or crosslinking agent is present in an amount of at least 1% by weight, such as 1 to 10% by weight or 5 to 10% by weight, based on total weight of polyol that is present in the polyurethane foam-forming reaction mixture.

Further, if desired, the polyol blend may comprise a natural oil or a NOP, though the presence of such material is not necessary. For example, if desired, any naturally occurring plant oil, plant oil product, animal-derived fat or oil, may be used. Examples of such natural oils include, for example, cashew oil, soybean oil, palm oil, palm kernel oil, castor oil, tall oil, canola oil, rapeseed oil, corn oil, jatropha oil, peanut oil, cottonseed oil, linseed oil, lard, tallow, bodied soybean oil, epoxidized soybean oil, camelina oil, lipids derived from algae, lesquerella oil, limnanthes (meadowfoam) oil and combinations of any thereof.

As previously mentioned, the polyurethane foam-forming reaction mixture comprises a blowing agent composition. More specifically, in some implementations, the blowing agent composition comprises water present in an amount of at least 90% by weight, such as at least 95% by weight, at least 99% by weight, or, in some cases, 100% by weight, based on total weight of blowing agent composition.

Suitable blowing agents that may be used in combination with water, albeit in a relatively small amount, include any of a variety of physical blowing agents, for example. Examples of physical blowing agents are halogenated blowing agents, such as hydrofluoroolefins (“HFOs”), including hydrochlorofluoroolefins (“HFCOs”), chlorofluorocarbons (“CFCs”), hydrogen-containing chlorofluorocarbons (“HCFCs”), hydrofluorocarbons (“HFCs”), and hydrocarbons, such as butane, n-pentane, cyclopentane, hexane, and/or isopentane (i.e. 2-methylbutane). In some embodiments, however, the polyurethane foam-forming reaction mixtures of this specification are substantially or, in some cases, completely free, of other physical blowing agents, such as other halogenated blowing agents, such as CFCs, HCFCs, HFCs and/or hydrocarbons, such as butane, n-pentane, cyclopentane, hexane, and/or isopentane (i.e. 2-methylbutane). As used herein, “substantially free” when used with reference to these physical blowing agents, means that the blowing agent is present, if at all, in an amount of less than 10% by weight, such no more than 5% by weight or no more than 1% by weight, based on total weight of the blowing agent composition.

In certain implementations, water is present in an amount of 0.5 to 10% by weight, 1 to 5% by weight, or 1 to 2% by weight, based on total weight of the polyurethane foam-forming reaction mixture.

In many cases, the polyurethane foam-forming reaction mixture further comprises a catalyst. A wide variety of catalysts may be employed, such as tertiary amines, tertiary phosphines, various metal chelates, acid metal salts, strong bases, various metal alcoholates and phenolates, and metal salts of organic acids. For example, the catalyst may include an organometallic catalyst and/or tertiary amine catalyst.

Specific examples of suitable tertiary amine catalysts are, without limitation, pentamethyl diethylenetriamine, N,N-dimethyl cyclohexylamine, N,N′,N″-tris(3-dimethylaminopropyl-) hexahydro triazine, tetramethyl ethylenediamine, tetraethylene diamine and benzyl dimethylamine, or a combination of any two or more thereof. Specific examples of suitable organometallic catalysts are, without limitation, dibutyltin dilaurate, dibutyltin diacetate, stannous octoate, potassium octoate, potassium acetate, or a combination thereof.

In certain implementations, the modified amine catalyst comprises the reaction product of (1) an amine, such as those represented by the formula R₂—N—R′ₓ—NH₂, where R and R′, which may be the same or different, each represent a hydrocarbon and x represents an integer, such as N,N-dimethyl-propylene diamine, with (2) a natural oil, such as castor oil or any fatty acid, such as tall oil. Thus, in some implementations, a modified amine catalyst that is a reaction product of N,N-dimethyl-propylene diamine with tall oil is employed.

In some implementations, the catalyst, such as foregoing modified amine catalyst, is present in an amount of 0.5 to 2% by weight, such as 0.7 to 1.2% by weight, based on total weight of the polyurethane foam-forming reaction mixture.

In some implementations, the polyurethane foam-forming reaction mixtures of this specification also comprise a surfactant. Any suitable surfactant can be used including organosilicon compounds, such as polysiloxane-polyalkylene block copolymers, such as a polyether-modified polysiloxane, polyethylene glycol ethers of long chain alcohols, tertiary amine or alkanolamine salts of long chain alkyl acid sulfate esters, alkylsulfonic esters, or alkylarylsulfonic acids. Such surfactants are employed in amounts sufficient to stabilize the foaming reaction mixture against collapse and the formation of large and uneven cells. In some embodiments, surfactant is utilized in an amount of 0.1 to 5.0% by weight or 0.5 to 1% by weight, based on total weight of the polyurethane foam-forming reaction mixture.

Additional materials may optionally be included in the polyurethane foam-forming reaction mixtures of this specification, such as pigments, colorants, fillers, antioxidants, flame retardants, plasticizers, fungistatic and bacteriostatic agents, and fillers, among others.

The polyurethane foam-forming reaction mixtures also include a polyisocyanate composition. As used herein, the term “polyisocyanate” refers to an organic compound containing two or more isocyanate groups (—N═C═O).

More specifically, in the polyurethane foam-forming reaction mixtures of this specification, the polyisocyanate composition comprises mMDI. In the context of the present application “mMDI” refers to a polyisocyanate mixture consisting of one or more compounds selected from 4,4′-diphenylmethane diisocyanate, 2,4′-diphenylmethane diisocyanate and 2,2′-diphenylmethane diisocyanate. For example, in some implementations, the mMDI includes, based on total weight of mMDI (i) 0.1 to 5% by weight, such as 0.1 to 3% by weight, or 0.4 to 2.5% by weight, of 2,2′-diphenylmethane diisocyanate, (ii) 1 to 20% by weight, such as 5 to 17% by weight, of 2,4′-diphenylmethane diisocyanate, and (iii) 70 to 95% by weight, such as 80 to 95% by weight, of 4,4′-diphenylmethane diisocyanate.

In some implementations, mMDI is present in an amount of 30 to 50% by weight, 40 to 50% by weight, or 44 to 46% by weight, based on total weight of the polyisocyanate composition, i.e., based on total weight of polyisocyanate that is present in the polyurethane foam-forming reaction mixture.

In the polyurethane foam-forming reaction mixtures of this specification, the polyisocyanate composition also comprises pMDI. As used herein, “pMDI” refers to homologues of mMDI that have an isocyanate functionality of more than 2. The general formula of pMDI can be represented by the general structure:

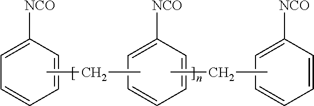

in which n is an integer having a value of 1 or more.

In some implementations, pMDI is present in an amount of 30 to 50% by weight, 40 to 50% by weight, or 44 to 46% by weight, based on total weight of the polyisocyanate composition, i.e., based on total weight of polyisocyanate that is present in the polyurethane foam-forming reaction mixture.

Moreover, in the polyurethane foam-forming reaction mixtures of this specification mMDI and pMDI are present in a ratio, by weight, of 0.9:1 to 1.1:1, such as 0.95:1 to 1.1:1, 1.0:1 to 1.1:1, 1.0:1 to 1.05:1 or 1.0:1 to 1.02:1.

As previously mentioned, the polyisocyanate composition present in the foam-forming reaction mixtures of this specification also includes PPL. As used herein, “PPL” or “polyisocyanate prepolymer” refers to a prepolymer that is a reaction product of mMDI and/or pMDI and one or more isocyanate-reactive compounds containing an average isocyanate reactive group functionality of greater than 1.2, in which the mMDI and/or pMDI is present in a stoichiometric excess, thereby resulting in a isocyanate-functional prepolymer. In some embodiments, the isocyanate-reactive compounds comprise a polyether polyol and/or polyester polyol. Processes for the producing PPL are known in the art.

As indicated earlier, in the polyurethane foam-forming reaction mixtures of this specification, PPL is present in an amount of 8 to 12% by weight, such as 9 to 11% by weight or 9 to 10% by weight, based on total weight of the polyisocyanate composition, i.e., based on total weight of polyisocyanate that is present in the polyurethane foam-forming reaction mixture. Moreover, in the polyurethane foam-forming reaction mixtures of this specification, mMDI and PPL are present in a ratio, by weight, of 4.7:1 to 5.3:1, such as 4.7:1 to 5.0:1, or 4.8:1 to 4.9:1.

In certain implementations, the polyisocyanate composition has an NCO content of 25 to 35% by weight, 29 to 34% by weight, or 29.0 to 32.0% by weight, based on the total weight of the polyisocyanate composition. In addition, in some implementations, the polyisocyanate composition has a viscosity at 25 °C (measured according to EN ISO 3219 October 1994) of 100 to 750 mPa·s, such as 100 to 600 mPa·s, or 150 to 450 mPa·s. In some implementations, the polyisocyanate composition has an average isocyanate functionality of 2.1 to 3.2, such as 2.4 to 2.8, or 2.5 to 2.7.

In fact, it was a surprising discovery that the particular polyurethane foam-forming reaction mixtures of this specification, which utilize a polyisocyanate composition comprising mMDI, pMDI, and PPL each in specified amounts, can produce polyurethane foams that exhibit desirable combination of physical properties, such as tensile strength, elongation, at compressive strength, at the high temperatures used in a dry film adhesive process for producing a multi-later composite article, such as an automotive hoodliner or headliner.

In certain embodiments, the polyol(s) is mixed with the polyisocyanate composition in a ratio by weight of isocyanate to polyol (an “A/B Ratio”) of 150:100 to 250:100, such as 180:100 to 220:100. In some embodiments, polyurethane foam-forming reaction mixture has a NCO/OH Index of 0.9 to 1.5, such as 1.0 to 1.4, or 1.1 to 1.3, in which NCO/OH Index refers to the ratio of reactive hydrogen atoms of the isocyanate-reactive compounds in the polyurethane foam-forming reaction mixture to the number of NCO groups in the polyurethane foam-forming reaction mixture.

Polyurethane foams can be produced by mixing the polyisocyanate composition with the polyol(s), such as, for example, by using a low-pressure foaming machine. A foam slab can be produced discontinuously, for example, by pouring the foamable mixture into a large box having a base area which corresponds to that of the article to be formed therefrom, e.g., a car roof. The polyurethane foams produced in accordance with this specification, in some implementations, have a density of 20 to 50 kg/m³, such as 35 to 45 kg/m³. In some cases, the reaction mixture is activated so that the foaming reaction begins after about 60 seconds, measured from emergence of the first amount from the mixing head (cream time). In some cases, after about 200 seconds, the foam sets and, after about 260 seconds, the blow-out process begins, i.e., the sudden evaporation of a mixture of steam and CO₂, leaving a number of small craters on the surface of the slab that is the outward sign that the foam cells have opened.

Thus, in some implementations, the polyurethane foams produced from the polyurethane foam-forming reaction mixtures of this specification are open-celled foams (60-94% by volume, ASTM-D-1940-42T) which are elastic and formable at room temperature. These foams may be used to produce automotive interior parts, such as hoodliners and headliners having complicated shapes. The foams can have glass transition temperatures of approximately 150 °C and, hence, high heat resistance. The foams can be sufficiently rigid so that warm moldings can be removed without damage from a mold which has been heated at 130° to 140 °C. In addition, the foams can have almost no resilience, so that edges which are tightly compressed to different extents retain their cross-section.

The polyurethane foams produced from the polyurethane foam-forming reaction mixtures of this specification may be particularly useful in producing multi-layered composite articles. Such multi-layered composite articles may comprise: (a) a polyurethane foam core; (b) an adhesive layer in contact with and attached to at least one surface of the foam core; and (c) a fiber-containing layer in contact with and adhered to the adhesive layer.

More specifically, such polyurethane foams can be particularly suitable for producing such multi-layer composite articles by a thermoforming process that utilizes a dry film adhesive layer. Such processes may comprise: (a) forming a multi-layer assembly comprising (1) a polyurethane foam core having a pair of opposed major surfaces; (2) a thermoplastic adhesive film deposited over at least one of the major surfaces of the polyurethane foam core; and (3) a fiber-reinforced mat deposited over the thermoplastic adhesive film; (b) melting the thermoplastic adhesive film by heating the multi-layer assembly to a temperature of 150 °C to 250 °C to form a multi-layer composite; and (c) shaping the multi-layer composite. In these processes, the polyurethane foam core comprises the reaction product of a polyurethane foam-forming reaction mixture of the type described earlier in this specification.

As indicated, in addition to the polyurethane foam core, which may be embodied in the form of a foam sheet having two major (by “major” is meant the two surfaces of the foam sheet with the largest surfaces area) opposed surfaces, the multi-layered composite article may comprise an adhesive layer in contact with and attached to one or both major surfaces of the foam sheet, and a fiber containing layer in contact with and adhered to the adhesive layer(s), such as is the case with automotive headliners and hoodliners. In the methods of this specification, the adhesive layer is produced from a thermoplastic adhesive film that is melted by heating the multi-layer assembly to a temperature of 150 °C to 250 °C, such as 160° to 220 °C or 170 °C to 190 °C. In some implementations, the adhesive layer(s) comprises a polyolefin (such as polyethylene and polypropylene), polyester, nylon, poly(vinyl chloride), polyurea (such as the reaction product of water and an isocyanate), polyurethane, polyacrylic, latex, a styrene-butadiene polymers, a nitrile-butadiene polymer, a silicone polymer, a mixture thereof, a copolymer thereof or an interpenetrating network thereof. In certain embodiments, each adhesive layer, if two or more adhesive layers are present, comprise the same polymer.

The fiber containing layer(s) can comprise woven or non-woven fibers. The fibers of the fiber containing layer(s) may be in the form of, for example, chopped fibers, such as synthetic or natural fibers, including glass fibers, for example.

The multi-layer composite articles may comprise additional layers, such as, for example, a textile cover layer which may be attached to a flexible foam layer that is adhered to one of the fiber containing layers and a scrim layer attached to the other fiber-containing layer, as is typical, for example, of an automotive headliner configuration.

In some implementations, the process for making such multi-layer composite articles comprises: (1) sandwiching an open-celled polyurethane foam produced from a polyurethane foam-forming reaction mixtures of this specification between fiber-reinforced mats to which a thermoplastic adhesive film is applied, (2) covering one of the fiber-reinforced mats with a film, and (3) covering the other fiber-reinforced mat with a textile fabric; (b) placing the resulting multi-layer assembly in a mold, (c) closing the mold and heating the multi-layer assembly therein to a temperature of 150 °C to 250 °C, such as 160° to 220 °C or 170 °C to 190 °C, to melt the thermoplastic adhesive film; and (d) removing the resulting molded article from the mold.

Various aspects of the subject matter described herein are set out in the following numbered Paragraphs:

Paragraph 1. A polyurethane foam-forming reaction mixture comprising: (1) a polyol; (2) a blowing agent composition; (3) a catalyst; and (4) a polyisocyanate composition comprising: (a) monomeric diphenylmethane diisocyanate (mMDI), (ii) polyphenylpolymethylene polyisocyanate (pMDI); and (iii) an isocyanate-terminated prepolymer based on mMDI and/or pMDI (PPL), wherein (i) mMDI and pMDI are present in a ratio, by weight, of 0.9:1 to 1.1:1, (ii) PPL is present in an amount of 8 to 12% by weight, based on total weight of the polyisocyanate composition, and (iii) mMDI and PPL are present in a ratio, by weight, of 4.7:1 to 5.3:1.

Paragraph 2. The polyurethane foam-forming reaction mixture of paragraph 1, wherein the polyol comprises a blend or two or more different polyols.

Paragraph 3. The polyurethane foam-forming reaction mixture of paragraph 1 or paragraph 2, wherein the polyol comprises a polyether polyol (1) having a functionality of 2 to 6, 2 to 4, 2.5 to 3.5, or 3, and an OH number of 20 to 50 mg KOH/g polyether polyol (1), 25 to 40 mg KOH/g polyether polyol (1) or 26 to 32 mg KOH/g polyether polyol (1).

Paragraph 4. The polyurethane foam-forming reaction mixture of paragraph 3, wherein the polyether polyol (1) has a (poly)oxyethylene content of 0 to 50% by weight, 1 to 40% by weight, 1 to 30% by weight, 10 to 30% by weight, or 10 to 20% by weight, based on the total weight of the polyether polyol, such as where the foregoing polyether polyol has more than 50 mol %, 70 to 90 mol % or 70 to 80 mol %, of primary OH groups.

Paragraph 5. The polyurethane foam-forming reaction mixture paragraph 3 or paragraph 4, wherein the polyether polyol (1) is present in an amount of at least 30% by weight, 30 to 60% by weight, 30 to 50% by weight or 30 to 40% by weight, based on total weight of polyols in the polyurethane foam-forming reaction mixture.

Paragraph 6. The polyurethane foam-forming reaction mixture of paragraph 1 to paragraph 5, wherein the polyol comprises a polyether polyol (2) having a functionality of 2 to 6, 2 to 4, or 2 to 3, and an OH number of 200 to 600 mg KOH/g polyether polyol (2), 300 to 600 KOH/g polyether polyol (2), 400 to 600 mg KOH/g polyether polyol (2), or 450 to 550 mg KOH/g polyether polyol (2), such as where the foregoing polyether polyol (2) has a (poly)propylene content of at least 70% by weight, at least 80% by weight, at least 90% by weight, at least 95% by weight, or 100% by weight, based on the total weight of the polyether polyol (2).

Paragraph 7. The polyurethane foam-forming reaction mixture of paragraph 6, wherein the polyether polyol (2) is present in an amount of at least 40% by weight, 40 to 80% by weight, 40 to 70% by weight or 40 to 60% by weight, based on total weight of polyol that is present in the polyurethane foam-forming reaction mixture.

Paragraph 8. The polyurethane foam-forming reaction mixture of paragraph 6 or paragraph 7, wherein the sum of the amount of polyether polyol (1) and polyether polyol (2) is at least 80% by weight, at least 85% by weight, or at least 90% by weight, based on total weight of polyol that is present in the polyurethane foam-forming reaction mixture.

Paragraph 9. The polyurethane foam-forming reaction mixture of one of paragraph 1 to paragraph 8, wherein the polyol comprises at least 60% by weight, 60 to 95% by weight or 70 to 90% by weight of a difunctional, trifunctional or mixture of di- and tri-functional hydroxyl polyether polyols, such as where the polyol comprises, based on total weight of polyol present in the polyurethane foam-forming reaction mixture: (i) 20 to 40% by weight or 25 to 35% by weight, of a glycerin-started (poly)propylene triol having an OH number of 400 to 600 mg KOH/g or 450 to 500 mg KOH/g, (ii) 30 to 50% by weight or 35 to 45% by weight, of a glycerin-started poly(propylene/ethylene oxide) triol having an OH number of 20 to 50 mg KOH/g, 25 to 40 mg KOH/g or 26 to 32 mg KOH/g, and (iii) 10 to 30% by weight or 15 to 25% by weight, of a (poly)propylene glycol having an OH number of 400 to 600 mg KOH/g or 500 to 600 mg KOH/g.

Paragraph 10. The polyurethane foam-forming reaction mixture of one of paragraph 1 to paragraph 10, with the proviso that the polyol does not include any polyester polyol.

Paragraph 11. The polyurethane foam-forming reaction mixture of one of paragraph 1 to paragraph 10, wherein the polyurethane foam-forming reaction mixture comprises a chain extender and/or crosslinker containing at least two isocyanate-reactive groups and a molecular weight of 60 to 160, such as glycerin, butanediol, ethylene glycol, diethylene glycol, propylene glycol, ethylenediamine, ethanolamine, triethanolamine, trimethylolpropane and pentaerythritol, including mixtures of two or more thereof.

Paragraph 12. The polyurethane foam-forming reaction mixture of paragraph 11, wherein the chain extender and/or crosslinker is present in an amount of at least 1% by weight, 1 to 10% by weight or 5 to 10% by weight, based on total weight of polyol that is present in the polyurethane foam-forming reaction mixture.

Paragraph 13. The polyurethane foam-forming reaction mixture of one of paragraph 1 to paragraph 12, wherein the blowing agent composition comprises water present in an amount of at least 90% by weight, at least 95% by weight, at least 99% by weight, or 100% by weight, based on total weight of blowing agent composition.

Paragraph 14. The polyurethane foam-forming reaction mixture of paragraph 13, wherein the blowing agent composition is substantially free of physical blowing agents.

Paragraph 15. The polyurethane foam-forming reaction mixture of paragraph 13 or paragraph 14, wherein water is present in an amount of 0.5 to 10% by weight, 1 to 5% by weight, or 1 to 2% by weight, based on total weight of the polyurethane foam-forming reaction mixture.

Paragraph 16. The polyurethane foam-forming reaction mixture of one of paragraph 1 to paragraph 15, wherein the catalyst comprises a reaction product of (1) an amine, such as those represented by the formula R₂—N—R′ₓ—NH₂, where R and R′, which may be the same or different, each represent a hydrocarbon and x represents an integer, such as N,N-dimethyl-propylene diamine, with (2) a natural oil, such as castor oil or any fatty acid, such as tall oil, such as where the catalyst is a reaction product of N,N-dimethyl-propylene diamine with tall oil.

Paragraph 17. The polyurethane foam-forming reaction mixture of one of paragraph 1 to paragraph 16, wherein the catalyst is present in an amount of 0.5 to 2% by weight, such as 0.7 to 1.2% by weight, based on total weight of the polyurethane foam-forming reaction mixture.

Paragraph 18. The polyurethane foam-forming reaction mixture of one of paragraph 1 to paragraph 17, wherein the mMDI comprises, based on total weight of mMDI (i) 0.1 to 5% by weight, 0.1 to 3% by weight, or 0.4 to 2.5% by weight, of 2,2′-diphenylmethane diisocyanate, (ii) 1 to 20% by weight or 5 to 17% by weight, of 2,4′-diphenylmethane diisocyanate, and (iii) 70 to 95% by weight or 80 to 95% by weight, of 4,4′-diphenylmethane diisocyanate.

Paragraph 19. The polyurethane foam-forming reaction mixture of one of paragraph 1 to paragraph 18, wherein mMDI is present in an amount of 30 to 50% by weight, 40 to 50% by weight, or 44 to 46% by weight, based on total weight of the polyisocyanate composition.

Paragraph 20. The polyurethane foam-forming reaction mixture of one of paragraph 1 to paragraph 19, wherein pMDI is present in an amount of 30 to 50% by weight, 40 to 50% by weight, or 44 to 46% by weight, based on total weight of the polyisocyanate composition.

Paragraph 21. The polyurethane foam-forming reaction mixture of one of paragraph 1 to paragraph 20, wherein mMDI and pMDI are present in a ratio, by weight, of 0.95:1 to 1.1:1, 1.0:1 to 1.1:1, 1.0:1 to 1.05:1 or 1.0:1 to 1.02:1.

Paragraph 22. The polyurethane foam-forming reaction mixture of one of paragraph 1 to paragraph 21, wherein PPL is present in an amount of 9 to 11% by weight or 9 to 10% by weight, based on total weight of the polyisocyanate composition.

Paragraph 23. The polyurethane foam-forming reaction mixture of one of paragraph 1 to paragraph 22, wherein mMDI and PPL are present in a ratio, by weight, of 4.7:1 to 5.0:1, or 4.8:1 to 4.9:1.

Paragraph 24. The polyurethane foam-forming reaction mixture of one of paragraph 1 to paragraph 23, wherein the polyisocyanate composition has an NCO content of 25 to 35% by weight, 29 to 34% by weight, or 29.0 to 32.0% by weight, based on the total weight of the polyisocyanate composition.

Paragraph 25. The polyurethane foam-forming reaction mixture of one of paragraph 1 to paragraph 24, wherein the polyisocyanate composition has a viscosity at 25 °C (measured according to EN ISO 3219 October 1994) of 100 to 750 mPa·s, 100 to 600 mPa·s, or 150 to 450 mPa·s.

Paragraph 26. The polyurethane foam-forming reaction mixture of one of paragraph 1 to paragraph 25, wherein the polyisocyanate composition has an average isocyanate functionality of 2.1 to 3.2, such as 2.4 to 2.8, or 2.5 to 2.7.

Paragraph 27. The polyurethane foam-forming reaction mixture of one of paragraph 1 to paragraph 26, wherein the polyisocyanate composition and the polyol are present in a ratio by weight of 150:100 to 250:100 or 180:100 to 220:100.

Paragraph 28. The polyurethane foam-forming reaction mixture of one of paragraph 1 to paragraph 27, wherein the polyurethane foam-forming reaction mixture has an NCO/OH index of 0.9 to 1.5, 1.0 to 1.4, or 1.1 to 1.3.

Paragraph 29. A method of producing a polyurethane foam comprising pouring the polyurethane foam-forming reaction mixture of one of paragraph 1 to paragraph 28 into a box having a base area which corresponds to that of the article to be formed therefrom, such as a car roof.

Paragraph 30. A polyurethane foam comprising the reaction product of the polyurethane foam-forming reaction mixture of one of paragraph 1 to paragraph 28 or produced from the method of paragraph 29.

Paragraph 31. The polyurethane foam of paragraph 30, wherein the polyurethane foam has a density of 20 to 50 kg/m³ or 35 to 45 kg/m³.

Paragraph 32. The polyurethane foam of paragraph 30 or paragraph 31, wherein the polyurethane foam is an open-celled foam.

Paragraph 33. The polyurethane foam of one of paragraph 30 to paragraph 32, wherein the polyurethane foam has a glass transition temperature of at least 150 °C.

Paragraph 34. A multi-layered composite article comprising: (a) a polyurethane foam core comprising the polyurethane foam of one of paragraph 30 to paragraph 33; (b) an adhesive layer in contact with and attached to at least one surface of the foam core; and (c) a fiber-containing layer in contact with and adhered to the adhesive layer.

Paragraph 35. The multi-layered composite article of paragraph 34, wherein the fiber containing layer comprises glass fibers.

Paragraph 36. The multi-layered composite article of paragraph 34 or paragraph 35, wherein the multi-layer composite article further comprises a textile cover layer attached to a flexible foam layer that is adhered to a fiber containing layer and a scrim layer attached to another fiber-containing layer.

Paragraph 37. The multi-layered composite article of one of paragraph 34 to paragraph 36, wherein embodied as an automotive headliner or hoodliner.

Paragraph 38. A process for producing a multi-layer composite article comprising: (a) forming a multi-layer assembly comprising: (1) a polyurethane foam core having a pair of opposed major surfaces; (2) a thermoplastic adhesive film deposited over at least one of the major surfaces of the polyurethane foam core; and (3) a fiber-reinforced mat deposited over the thermoplastic adhesive film; (b) melting the thermoplastic adhesive film by heating the multi-layer assembly to a temperature of 150 °C to 250 °C to form a multi-layer composite; and (c) shaping the multi-layer composite, wherein the polyurethane foam core comprises a reaction product of a polyurethane foam-forming reaction mixture comprising: (1) a polyol; (2) a blowing agent composition; (3) a catalyst; and (4) a polyisocyanate composition comprising: (i) mMDI, (ii) pMDI; and (iii) PPL, in which mMDI and pMDI are present in a ratio, by weight, of 0.9:1 to 1.1:1, PPL is present in an amount of 8 to 12% by weight, based on total weight of polyisocyanate composition, and mMDI and PPL are present in a ratio, by weight, of 4.7:1 to 5.3:1.

Paragraph 39. The process of paragraph 38, wherein the polyol comprises a blend or two or more different polyols.

Paragraph 40. The process of paragraph 38 or paragraph 39, wherein the polyol comprises a polyether polyol (1) having a functionality of 2 to 6, 2 to 4, 2.5 to 3.5, or 3, and an OH number of 20 to 50 mg KOH/g polyether polyol (1), 25 to 40 mg KOH/g polyether polyol (1) or 26 to 32 mg KOH/g polyether polyol (1).

Paragraph 41. The process of paragraph 40, wherein the polyether polyol (1) has a (poly)oxyethylene content of 0 to 50% by weight, 1 to 40% by weight, 1 to 30% by weight, 10 to 30% by weight, or 10 to 20% by weight, based on the total weight of the polyether polyol, such as where the foregoing polyether polyol has more than 50 mol %, 70 to 90 mol % or 70 to 80 mol %, of primary OH groups.

Paragraph 42. The process of paragraph 40 or paragraph 41, wherein the polyether polyol (1) is present in an amount of at least 30% by weight, 30 to 60% by weight, 30 to 50% by weight or 30 to 40% by weight, based on total weight of polyols in the polyurethane foam-forming reaction mixture.

Paragraph 43. The process of one of paragraph 38 to paragraph 42, wherein the polyol comprises a polyether polyol (2) having a functionality of 2 to 6, 2 to 4, or 2 to 3, and an OH number of 200 to 600 mg KOH/g polyether polyol (2), 300 to 600 KOH/g polyether polyol (2), 400 to 600 mg KOH/g polyether polyol (2), or 450 to 550 mg KOH/g polyether polyol (2), such as where the foregoing polyether polyol (2) has a (poly)propylene content of at least 70% by weight, at least 80% by weight, at least 90% by weight, at least 95% by weight, or 100% by weight, based on the total weight of the polyether polyol (2).

Paragraph 44. The process of paragraph 43, wherein the polyether polyol (2) is present in an amount of at least 40% by weight, 40 to 80% by weight, 40 to 70% by weight or 40 to 60% by weight, based on total weight of polyol that is present in the polyurethane foam-forming reaction mixture.

Paragraph 45. The process of one of paragraph 43 or paragraph 44, wherein the sum of the amount of polyether polyol (1) and polyether polyol (2) is at least 80% by weight, at least 85% by weight, or at least 90% by weight, based on total weight of polyol that is present in the polyurethane foam-forming reaction mixture.

Paragraph 46. The process of one of paragraph 38 to paragraph 45, wherein the polyol comprises at least 60% by weight, 60 to 95% by weight or 70 to 90% by weight of a difunctional, trifunctional or mixture of di- and tri-functional hydroxyl polyether polyols, such as where the polyol comprises, based on total weight of polyol present in the polyurethane foam-forming reaction mixture: (i) 20 to 40% by weight or 25 to 35% by weight, of a glycerin-started (poly)propylene triol having an OH number of 400 to 600 mg KOH/g or 450 to 500 mg KOH/g, (ii) 30 to 50% by weight or 35 to 45% by weight, of a glycerin-started poly(propylene/ethylene oxide) triol having an OH number of 20 to 50 mg KOH/g, 25 to 40 mg KOH/g or 26 to 32 mg KOH/g, and (iii) 10 to 30% by weight or 15 to 25% by weight, of a (poly)propylene glycol having an OH number of 400 to 600 mg KOH/g or 500 to 600 mg KOH/g.

Paragraph 47. The process of one of paragraph 38 to paragraph 46, with the proviso that the polyol does not include any polyester polyol.

Paragraph 48. The process of one of paragraph 38 to paragraph 47, wherein the polyurethane foam-forming reaction mixture comprises a chain extender and/or crosslinker containing at least two isocyanate-reactive groups and a molecular weight of 60 to 160, such as glycerin, butanediol, ethylene glycol, diethylene glycol, propylene glycol, ethylenediamine, ethanolamine, triethanolamine, trimethylolpropane and pentaerythritol, including mixtures of two or more thereof.

Paragraph 49. The process of paragraph 48, wherein the chain extender and/or crosslinker is present in an amount of at least 1% by weight, 1 to 10% by weight or 5 to 10% by weight, based on total weight of polyol that is present in the polyurethane foam-forming reaction mixture.

Paragraph 50. The process of one of paragraph 38 to paragraph 49, wherein the blowing agent composition comprises water present in an amount of at least 90% by weight, at least 95% by weight, at least 99% by weight, or 100% by weight, based on total weight of blowing agent composition.

Paragraph 51. The process of paragraph 50, wherein the blowing agent composition is substantially free of physical blowing agents.

Paragraph 52. The process of paragraph 50 or paragraph 51, wherein water is present in an amount of 0.5 to 10% by weight, 1 to 5% by weight, or 1 to 2% by weight, based on total weight of the polyurethane foam-forming reaction mixture.

Paragraph 53. The process of one of paragraph 38 to paragraph 52, wherein the catalyst comprises a reaction product of (1) an amine, such as those represented by the formula R₂—N—R′ₓ—NH₂, where R and R′, which may be the same or different, each represent a hydrocarbon and x represents an integer, such as N,N-dimethyl-propylene diamine, with (2) a natural oil, such as castor oil or any fatty acid, such as tall oil, such as where the catalyst is a reaction product of N,N-dimethyl-propylene diamine with tall oil.

Paragraph 54. The process of one of paragraph 38 to paragraph 53, wherein the catalyst is present in an amount of 0.5 to 2% by weight, such as 0.7 to 1.2% by weight, based on total weight of the polyurethane foam-forming reaction mixture.

Paragraph 55. The process of one of paragraph 38 to paragraph 54, wherein the mMDI comprises, based on total weight of mMDI (i) 0.1 to 5% by weight, 0.1 to 3% by weight, or 0.4 to 2.5% by weight, of 2,2′-diphenylmethane diisocyanate, (ii) 1 to 20% by weight or 5 to 17% by weight, of 2,4′-diphenylmethane diisocyanate, and (iii) 70 to 95% by weight or 80 to 95% by weight, of 4,4′-diphenylmethane diisocyanate.

Paragraph 56. The process of one of paragraph 39 to paragraph 56, wherein mMDI is present in an amount of 30 to 50% by weight, 40 to 50% by weight, or 44 to 46% by weight, based on total weight of the polyisocyanate composition.

Paragraph 57. The process of one of paragraph 38 to paragraph 56, wherein pMDI is present in an amount of 30 to 50% by weight, 40 to 50% by weight, or 44 to 46% by weight, based on total weight of the polyisocyanate composition.

Paragraph 58. The process of one of paragraph 38 to paragraph 57, wherein mMDI and pMDI are present in a ratio, by weight, of 0.95:1 to 1.1:1, 1.0:1 to 1.1:1, 1.0:1 to 1.05:1 or 1.0:1 to 1.02:1.

Paragraph 59. The process of one of paragraph 38 to paragraph 58, wherein PPL is present in an amount of 9 to 11% by weight or 9 to 10% by weight, based on total weight of the polyisocyanate composition.

Paragraph 60. The process of one of paragraph 38 to paragraph 59, wherein mMDI and PPL are present in a ratio, by weight, of 4.7:1 to 5.0:1, or 4.8:1 to 4.9:1.

Paragraph 61. The process of one of paragraph 38 to paragraph 60, wherein the polyisocyanate composition has an NCO content of 25 to 35% by weight, 29 to 34% by weight, or 29.0 to 32.0% by weight, based on the total weight of the polyisocyanate composition.

Paragraph 62. The process of one of paragraph 38 to paragraph 61, wherein the polyisocyanate composition has a viscosity at 25 °C (measured according to EN ISO 3219 October 1994) of 100 to 750 mPa·s, 100 to 600 mPa·s, or 150 to 450 mPa·s.

Paragraph 63. The process of one of paragraph 38 to paragraph 62, wherein the polyisocyanate composition has an average isocyanate functionality of 2.1 to 3.2, such as 2.4 to 2.8, or 2.5 to 2.7.

Paragraph 64. The process of one of paragraph 38 to paragraph 63, wherein the polyisocyanate and the polyol are present in a ratio by weight of 150:100 to 250:100 or 180:100 to 220:100.

Paragraph 65. The process of one of paragraph 38 to paragraph 64, wherein the polyurethane foam-forming reaction mixture has an NCO/OH index of 0.9 to 1.5, 1.0 to 1.4, or 1.1 to 1.3.

Paragraph 66. The process of one of paragraph 38 to paragraph 65, wherein the polyurethane foam core has a density of 20 to 50 kg/m³ or 35 to 45 kg/m³.

Paragraph 67. The process of one of paragraph 38 or paragraph 66, wherein the polyurethane foam core is an open-celled foam.

Paragraph 68. The process of one of paragraph 38 to paragraph 67, wherein the polyurethane foam core has a glass transition temperature of at least 150 °C.

Paragraph 69. The process of one of paragraph 38 to paragraph 68, wherein the multi-layer assembly is heated to a temperature of 160° to 220 °C or 170 °C to 190 °C, to melt the thermoplastic adhesive film.

Paragraph 70. The process of one of paragraph 38 to paragraph 69, wherein the fiber-reinforced mat comprises glass fibers.

Paragraph 71. A multi-layered composite article produced by the process of one of paragraph 38 to paragraph 70.

Paragraph 72. The multi-layered composite article of paragraph 71, wherein the multi-layer composite article further comprises a textile cover layer attached to a flexible foam layer that is adhered to a fiber containing layer and a scrim layer attached to another fiber-containing layer.

Paragraph 73. The multi-layered composite article of paragraph 71 or paragraph 72, wherein embodied as an automotive headliner or hoodliner.

The non-limiting and non-exhaustive examples that follow are intended to further describe various non-limiting and non-exhaustive embodiments without restricting the scope of the embodiments described in this specification.

### EXAMPLES

Foam-forming reaction mixtures were prepared using the ingredients and amounts (in parts by weight) set forth in the Tables below. The following materials were used:
POLYOL 1: a glycerin-initiated polyether polyol (with an oxide block of 83% propylene oxide and 17% ethylene oxide), having a functionality of 3, and an OH number of 28 mg KOH/g;
POLYOL 2: a propylene glycol-initiated polyether polyol (with an oxide block of 100% propylene oxide), having a functionality of 2, and an OH number of 515 mg KOH/g;
POLYOL 3: a glycerin-initiated polyether polyol (with an oxide block of 100% propylene oxide), having a functionality of 3, and an OH number of 470 mg KOH/g;
CATALYST: a modified amine catalyst which is the reaction product of tall oil with N,N-dimethyl-propylene diamine of the type described in U.S. Patent Application Publication No. 2008/0227879 A1;
SURFACTANT: silicone surfactant, Niax Silicone L-1260 from Momentive Performance Materials;
COLORANT 1: Colormatch® DR2205 black pigment from Vibrantz Technologies;
PPL 1: an isocyanate functional reaction product of (i) a mixture of mMDI and pMDI (in which 20 to 60% by weight of the total polyisocyanate is mMDI and 40 to 80% by weight of the total polyisocyanate is pMDI), and (ii) a diethylene glycol-phthalic anhydride initiated polyester polyol with a nominal functionality of 2 and an OH number of 245 to 270 mg KOH/g;
PPL 2: an isocyanate-functional reaction product of 4,4′-mMDI and tripropylene glycol; ISO 1: a mixture of 67.72 wt % mMDI and 32.28 wt % of pMDI, having a functionality of 2.39 and an NCO content of 32.30%;
ISO 2: a mixture of 45.70 wt % mMDI, 51.50 wt % of pMDI, and 2.80 wt % PPL 1, having a functionality of 2.69 and an NCO content of 31.94%;
ISO 3: a mixture of 49.44 wt % mMDI, 41.20 wt % of pMDI, and 9.36 wt % PPL 2, having a functionality of 2.47 and an NCO content of 29.89%;
ISO 4: a mixture of 50.79 wt % mMDI, 36.11 wt % of pMDI, and 13.10 wt % PPL 2, having a functionality of 2.53 and an NCO content of 29.08%;
ISO 5: a mixture of 41.96 wt % mMDI, 44.01 wt % of pMDI, and 14.04 wt % PPL 2, having a functionality of 2.62 and an NCO content of 28.66%;
ISO 6: a mixture of 43.55 wt % mMDI, 37.73 wt % of pMDI, and 18.72 wt % PPL 2, having a functionality of 2.53 and an NCO content of 27.83%;
ISO 7: a mixture of 56.74 wt % mMDI, 33.90 wt % of pMDI, and 9.36 wt % PPL 2, having a functionality of 2.53 and an NCO content of 30.20%;
ISO 8: a mixture of 45.44 wt % mMDI, 45.20 wt % of pMDI, and 9.36 wt % PPL 2, having a functionality of 2.60 and an NCO content of 29.79%; and
ISO 9: a mixture of 45.72 wt % mMDI, 44.92 wt % of pMDI, and 9.36 wt % PPL 2, having a functionality of 2.61 and an NCO content of 9.60%.

### Lab Procedure for Producing Foam Blocks

Two (2) “B-sides” were prepared by mixing the ingredients (amounts are in parts by weight) listed in Table 1.

TABLE 1

| INGREDIENT | B-SIDE 1 | B-SIDE 2 |
|---|---|---|
| POLYOL 1 | 36.4 | 36.7 |
| POLYOL 2 | 18.0 | 18.0 |
| POLYOL 3 | 28.0 | 28.0 |
| GLYCERINE | 8.0 | 8.0 |
| CATALYST | 3.8 | 3.8 |
| SURFACTANT | 1.0 | 1.0 |
| COLORANT | 0.5 | 0.5 |
| WATER | 4.3 | 4.0 |
| TOTAL | 100.0 | 100.0 |

The composition of the various polyisocyanates used to prepare foams is summarized in in Table 2 (amounts are in wt %).

TABLE 2

| | ISO 1 | ISO 2 | ISO 3 | ISO 4 | ISO 5 | ISO 6 | ISO 7 | ISO 8 | ISO 9 |
|---|---|---|---|---|---|---|---|---|---|
| mMDI | 67.72 | 45.70 | 49.44 | 50.79 | 41.96 | 43.55 | 56.74 | 45.44 | 45.72 |
| pMDI | 32.28 | 51.50 | 41.20 | 36.11 | 44.00 | 37.73 | 33.90 | 45.20 | 44.92 |
| PPL 1 | — | 2.80 | — | — | — | — | — | — | — |
| PPL 2 | — | — | 9.36 | 13.10 | 14.04 | 18.72 | 9.36 | 9.36 | 9.36 |
| mMDI:pMDI | 2.10 | 0.89 | 1.20 | 1.41 | 0.95 | 1.15 | 1.67 | 1.01 | 1.02 |
| weight ratio | | | | | | | | | |
| mMDI:PPL | — | 16.32 | 5.28 | 3.88 | 2.99 | 2.33 | 5.24 | 4.85 | 4.88 |
| weight ratio | | | | | | | | | |

To prepare foams, the “B-side” and the polyisocyanate were each conditioned for 16 hours at 25 °C. The formulations of each of the example foams is set forth in Table 3.

TABLE 3

| | FOAM | | | | | | | | |
|---|---|---|---|---|---|---|---|---|---|
| | 1 | 2 | 3 | 4 | 5 | 6 | 7 | 8 | 9 |
| Polyisocyanate | ISO 1 | ISO 2 | ISO 3 | ISO 4 | ISO 5 | ISO 6 | ISO 7 | ISO 8 | ISO 9 |
| B-side | 1 | 1 | 1 | 1 | 1 | 1 | 1 | 2 | 2 |
| A/B Ratio¹ | 180/100 | 190/100 | 195/100 | 200/100 | 203/100 | 209/100 | 193/100 | 195/100 | 196/100 |
| NCO/OH | 1.225 | 1.225 | 1.225 | 1.225 | 1.225 | 1.225 | 1.225 | 1.225 | 1.225 |
| Index | | | | | | | | | |

¹Parts by weight polyisocyanate/Parts by weight B-Side

The container used for the reaction was a 13½″×13½″×12″ tall wood box in which the sides were lined with polyethylene film, and a snug fitting cardboard tray was placed in the bottom of the box. A Foamat® digital data collection unit was used to monitor the foaming reaction in which a laser was used to monitor rate of rise and rise height of the foam, pressure transducers were used to monitor foaming pressure, and a thermocouple was used to monitor foam exotherm.

For each run: (1) ambient conditions were recorded (typically 20 °C and 50% relative humidity) and the data collection suite initialized; (2) a suitable amount of “B-side” was weighed in a 1.5-liter plastic container; (3) the desired amount of ISOCYANATE to result in an NCO/OH Index of 1.225:1 was then added to the same container and the components were mixed for 20 seconds at 2,800 rpm using a six-vane fin mixer with a 2½″ diameter impeller, and (4) 1,100 grams of the homogenized liquid was poured into the box. The actual amount charged to the box was recorded. In addition to the digital data, cream time and gel time were manually observed and recorded. After the gel time, the crown of the foam was observed for degas. Time of degas initiation and cessation was recorded and scored on a scale of 1-10, with 1 being very poor and 10 being very robust. After 15 minutes, the material inside the box was re-weighed, and weight loss was calculated. The foam crown continued to be monitored for tack-free time. After 30 minutes, the foam/liner/tray assembly was removed from the box; and after waiting at least 5 minutes, the liner and tray were removed from the reacted foam bun. The foam bun was then left to sit for at least 16 hours at ambient conditions, then cut down to a 11″×11″×6″ tall block using a bandsaw. The resulting block was weighed and the density calculated and recorded in kg/m³. The block was then sliced into 10 mm thick sheets for physical property testing.

DMA tan (δ) foam glass transition temperature was determined according to ASTM D 7028-07 (2024). Physical property testing was conducted 180 °C per the guidance of ASTM D 412-16 (2021), sections 6.2-6.4. The following tests were performed: tensile stress and elongation at break according to ASTM D 3574-17 Test E, and compressive stress at 10% strain and apparent compressive modulus according to ASTM D-1621-16 (2023). The target minimum value for each property is summarized in Table 4.

Results are in Table 5. Foams 1-7 are Comparative Examples and Foams 8-9 are Inventive Examples

TABLE 4

| | Target |
|---|---|
| Property | Minimum Value |
| tensile strength at break, kPa | 65 |
| elongation at break, % | 38 |
| compressive modulus, psi | 75 |
| compressive stress at 10% strain, psi | 5 |
| DMA tan(δ) - Tg, °C | 170 |

TABLE 5

| | FOAM | | | | | | | | |
|---|---|---|---|---|---|---|---|---|---|
| PROPERTY¹ | 1 | 2 | 3 | 4 | 5 | 6 | 7 | 8 | 9 |
| tensile strength at break, kPa | 41.4 | 75.0 | 58.6 | 37.1 | 54.9 | 35.3 | 43.7 | 66.2 | 59.7 |
| elongation at break, % | 52 | 27 | 43 | 50 | 34 | 43 | 51 | 39 | 40 |
| compressive modulus, psi | 30 | 136 | 70 | 32 | 50 | 31 | 35 | 87 | 76 |
| compressive stress at 10% strain, psi | 2.6 | 7.9 | 4.0 | 2.2 | 3.1 | 2.4 | 2.3 | 5.0 | 4.7 |
| DMA tan(δ)-Tg, °C | 159 | 160 | 157 | 148 | 155 | 150 | 148 | 179 | 176 |

¹Tensile strength at break, elongation at break, compressive modulus and compressive strength were evaluated at a foam temperature of 180 °C.

As is apparent, only Foam 8 and Foam 9 exhibited a combination of properties exceeding or at least near each of the target minimum values indicating their desirability for use in the manufacture of multi-layer composite articles at a dry film process temperature of 180 °C.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyurethane foam-forming reaction mixture comprising:
(1) a polyol;
(2) a blowing agent composition;
(3) a catalyst; and
(4) a polyisocyanate comprising: (a) monomeric diphenylmethane diisocyanate (mMDI), (ii) polyphenylpolymethylene polyisocyanate (pMDI); and (iii) an isocyanate-terminated prepolymer based on mMDI and/or pMDI (PPL),
wherein (i) mMDI and pMDI are present in a ratio, by weight, of 0.9:1 to 1.1:1, (ii) PPL is present in an amount of 8 to 12% by weight, based on total weight of polyisocyanate, and (iii) mMDI and PPL are present in a ratio, by weight, of 4.7:1 to 5.3:1.

2. The polyurethane foam-forming reaction mixture of claim 1, wherein the polyol comprises:
(a) a polyether polyol having a functionality of 2.5 to 3.5 and an OH number of 20 to 50 mg KOH/g; and
(b) a polyether polyol having a functionality of 2 to 3 and an OH number of 200 to 600 mg KOH/g.

3. The polyurethane foam-forming reaction mixture of claim 1, wherein the polyol comprises:
(a) 20 to 40% by weight, based on total weight of polyol, of a glycerin-started (poly)propylene triol having an OH number of 400 to 600 mg KOH/g;
(b) 30 to 50% by weight, based on total weight of polyol, of a glycerin-started poly(propylene/ethylene oxide) triol having an OH number of 20 to 50 mg KOH/g; and
(c) 10 to 30% by weight, based on total weight of polyol, of a (poly)propylene glycol having an OH number of 400 to 600 mg KOH/g.

4. The polyurethane foam-forming reaction mixture of claim 1, wherein the blowing agent composition comprises water present in an amount of at least 95% by weight, based on total weight of blowing agent composition.

5. The polyurethane foam-forming reaction mixture of claim 1, wherein the catalyst comprises a reaction product of (1) an amine represented by the formula R₂—N—R′ₓ—NH₂, where R and R′, which may be the same or different, each represent a hydrocarbon and x represents an integer, with (2) a natural oil.

6. The polyurethane foam-forming reaction mixture of claim 1, wherein the mMDI comprises (i) 0.1 to 5% by weight, based on total weight of mMDI, of 2,2′-diphenylmethane diisocyanate, (ii) 1 to 20% by weight, based on total weight of mMDI, of 2,4′-diphenylmethane diisocyanate, and (iii) 70 to 95% by weight, based on total weight of mMDI, of 4,4′-diphenylmethane diisocyanate.

7. The polyurethane foam-forming reaction mixture of claim 1, wherein mMDI is present in an amount of 30 to 50% by weight, based on total weight of polyisocyanate.

8. The polyurethane foam-forming reaction mixture of claim 7, wherein pMDI is present in an amount of 30 to 50% by weight, based on total weight of polyisocyanate.

9. The polyurethane foam-forming reaction mixture of claim 1, wherein mMDI and pMDI are present in a ratio, by weight, of 1.0:1 to 1.1:1.

10. The polyurethane foam-forming reaction mixture of claim 1, wherein the mMDI and PPL are present in a ratio, by weight, of 4.7:1 to 5.0:1.

11. A process for producing a multi-layer composite article comprising:
(a) forming a multi-layer assembly comprising:
(1) a polyurethane foam core having a pair of opposed major surfaces;
(2) a thermoplastic adhesive film deposited over at least one of the major surfaces of the polyurethane foam core; and
(3) a fiber-reinforced mat deposited over the thermoplastic adhesive film;
(b) melting the thermoplastic adhesive film by heating the multi-layer assembly to a temperature of 150 °C to 250 °C to form a multi-layer composite; and
(c) shaping the multi-layer composite,
wherein the polyurethane foam core comprises a reaction product of a polyurethane foam-forming reaction mixture comprising:
(1) a polyol;
(2) a blowing agent composition;
(3) a catalyst; and
(4) a polyisocyanate comprising: (i) mMDI, (ii) pMDI; and (iii) PPL, in which mMDI and pMDI are present in a ratio, by weight, of 0.9:1 to 1.1:1, PPL is present in an amount of 8 to 12% by weight, based on total weight of polyisocyanate, and mMDI and PPL are present in a ratio, by weight, of 4.7:1 to 5.3:1.

12. The process of claim 11, wherein the polyol comprises:
(a) a polyether polyol having a functionality of 2.5 to 3.5 and an OH number of 20 to 50 mg KOH/g; and
(b) a polyether polyol having a functionality of 2 to 3 and an OH number of 200 to 600 mg KOH/g.

13. The process of claim 11, wherein the polyol comprises:
(a) 20 to 40% by weight, based on total weight of polyol, of a glycerin-started (poly)propylene triol having an OH number of 400 to 600 mg KOH/g;
(b) 30 to 50% by weight, based on total weight of polyol, of a glycerin-started poly(propylene/ethylene oxide) triol having an OH number of 20 to 50 mg KOH/g; and
(c) 10 to 30% by weight, based on total weight of polyol, of a (poly)propylene glycol having an OH number of 400 to 600 mg KOH/g.

14. The process of claim 11, wherein the blowing agent composition comprises water present in an amount of at least 95% by weight, based on total weight of blowing agent composition.

15. The process of claim 11, wherein the catalyst comprises a reaction product of (1) an amine represented by the formula R₂—N—R′ₓ—NH₂, where R and R′, which may be the same or different, each represent a hydrocarbon and x represents an integer, with (2) a natural oil.

16. The process of claim 11, wherein the mMDI comprises (i) 0.1 to 5% by weight, based on total weight of mMDI, of 2,2′-diphenylmethane diisocyanate, (ii) 1 to 20% by weight, based on total weight of mMDI, of 2,4′-diphenylmethane diisocyanate, and (iii) 70 to 95% by weight, based on total weight of mMDI, of 4,4′-diphenylmethane diisocyanate.

17. The process of claim 11, wherein mMDI is present in an amount of 30 to 50% by weight, based on total weight of polyisocyanate.

18. The process of claim 17, wherein pMDI is present in an amount of 30 to 50% by weight, based on total weight of polyisocyanate.

19. The process of claim 11, wherein mMDI and pMDI are present in a ratio, by weight, of 1.0:1 to 1.1:1.

20. The process of claim 11, wherein the mMDI and PPL are present in a ratio, by weight, of 4.7:1 to 5.0:1.
